(19) United States
(12) Patent Application Publication
(10) Pub. No.: US 2025/0021816 A1
(43) Pub. Date: Jan. 16, 2025

(54) INFERENCE APPARATUS AND CONTROL METHOD

(71) Applicant: CANON KABUSHIKI KAISHA, Tokyo (JP)

(72) Inventors: DAI MIYAUCHI, Chiba (JP); HIROSHI KANEKO, Kanagawa (JP)

(21) Appl. No.: 18/763,667

(22) Filed: Jul. 3, 2024

(30) Foreign Application Priority Data
Jul. 11, 2023 (JP) 2023-113901

(51) Int. Cl. G06N 3/08

(52) U.S. Cl. CPC G06N 3/08

(57) ABSTRACT

An inference apparatus includes an inference unit that executes inference processing using a plurality of pieces of inference data, a determination unit that determines, for each of a plurality of pieces of input data inputted into the inference apparatus, whether each of the plurality of pieces of input data are suitable for the inference processing or unsuitable for the inference processing, and a decision unit that decides, in place of input data determined to be unsuitable, substitute data based on input data determined to be suitable. The inference unit applies the input data determined to be suitable and the substitute data to an inference model as the plurality of pieces of inference data and executes the inference processing.

### BACKGROUND

### Field

The present disclosure relates to a technique for inputting plural types of data and performing inference processing.

### Description of the Related Art

In recent years, artificial intelligence (AI) has been utilized in image processing for recognizing human faces, facial expressions, and the like in captured images. In image processing in which AI is used, captured images and the like are applied to a trained inference model as input data, machine learning-based inference processing is executed, and an inference result is outputted.

In this case, a single type of input data (single modal data) used for inference processing is not enough to improve inference accuracy. Accordingly, Japanese Patent Laid-Open No. 2022-2023 describes a technique for improving inference accuracy by performing processing for training an inference model using plural types of input data rather than performing training processing in which a single type of input data is used.

However, in Japanese Patent Laid-Open No. 2022-2023, when data which is not suitable for training processing is included in the plural types of input data, it becomes difficult to improve inference accuracy in inference processing in which an inference model trained with such unsuitable data is used.

### SUMMARY OF THE INVENTION

The present disclosure has been made in consideration of the aforementioned problems, and realizes techniques for improving inference accuracy even when data that is not suitable for training is included in plural types of input data.

In order to solve the aforementioned problems, the present disclosure provides an inference apparatus comprising: an inference unit that executes inference processing using a plurality of pieces of inference data; a determination unit that determines, for each of a plurality of pieces of input data inputted into the inference apparatus, whether each of the plurality of pieces of input data are suitable for the inference processing or unsuitable for the inference processing; and a decision unit that decides, in place of input data determined to be unsuitable, substitute data based on input data determined to be suitable, wherein the inference unit applies the input data determined to be suitable and the substitute data to an inference model as the plurality of pieces of inference data and executes the inference processing.

In order to solve the aforementioned problems, the present disclosure provides a method of controlling an interference apparatus operable to execute inference processing using a plurality of pieces of inference data, the method comprising: determining, for each of a plurality of pieces of input data inputted into the inference apparatus, whether each of the plurality of pieces of input data are suitable for the inference processing or unsuitable for the inference processing; and deciding, in place of input data determined to be unsuitable in the determining, substitute data based on input data determined to be suitable, wherein the input data determined to be suitable and the substitute data are applied to an inference model as the plurality of pieces of inference data and the inference processing is executed.

According to the present disclosure, it is possible to improve inference accuracy even when data that is not suitable for training is included in plural types of input data.

Further features of the present disclosure will become apparent from the following description of exemplary embodiments (with reference to the attached drawings).

### BRIEF DESCRIPTION OF THE DRAWINGS

FIG. 1 is a block diagram illustrating a configuration of an inference apparatus according to a first embodiment.

FIG. 2 is a diagram illustrating a configuration of an inference unit according to the first embodiment.

FIGS. 3A and 3B are diagrams illustrating image data inputted to the inference apparatus according to the first embodiment.

FIGS. 4A to 4D are diagrams illustrating sound data inputted to the inference apparatus according to the first embodiment.

FIGS. 5A and 5B are diagrams illustrating suitability determination results according to the first embodiment.

FIGS. 6A to 6C are diagrams illustrating a method of calculating characteristic information of input data and a method of deciding substitute data according to the first embodiment.

FIG. 7 is a diagram illustrating inference data according to the first embodiment.

FIG. 8 is a flowchart illustrating control processing for the first embodiment.

FIG. 9 is a diagram illustrating processing for training the inference model according to the first embodiment.

FIGS. 10A to 10C are diagrams illustrating the method of calculating characteristic information of input data and the method of deciding substitute data according to a second embodiment.

FIG. 11 is a diagram illustrating inference data according to the second embodiment.

FIGS. 12A to 12C are diagrams illustrating image data inputted to the inference apparatus according to a third embodiment.

FIGS. 13A to 13C are diagrams illustrating inference data according to the third embodiment.

FIG. 14 is a diagram illustrating image data inputted to the inference apparatus according to a fourth embodiment.

FIGS. 15A and 15B are diagrams illustrating inference data according to the fourth embodiment.

FIG. 16 is a block diagram illustrating a configuration of the inference apparatus according to a fifth embodiment.

FIG. 17 is a diagram illustrating a configuration of the inference unit according to the fifth embodiment.

FIGS. 18A to 18D are diagrams illustrating inference data according to the fifth embodiment.

FIG. 19 is a flowchart illustrating control processing for the fifth embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to an disclosure that requires all such features, and multiple such features may be combined as appropriate. Furthermore, in the attached drawings, the same reference numerals are given to the same or similar configurations, and redundant description thereof is omitted.

### First Embodiment

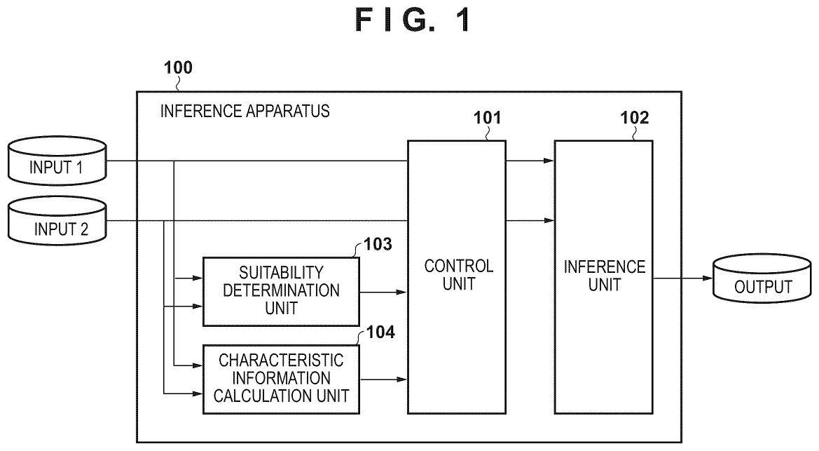

A first embodiment will be described with reference to FIGS. 1 to 9.

### <Apparatus Configuration>

First, a configuration and functions of an inference apparatus 100 according to the first embodiment will be described with reference to FIG. 1.

The inference apparatus 100 includes a control unit 101 and an inference unit 102 and executes inference processing using a trained inference model and parameters. The inference apparatus 100 applies plural input data to the inference model, performs multimodal inference processing, and outputs an inference result.

In the first embodiment, the inference apparatus 100 takes image data as input 1 and sound data as input 2 and outputs, as an inference result, a region focusing on people who are having a conversation in a captured image.

In the following, description will be given assuming that the input 1 is image data, the input 2 is sound data, and the output is a region of interest.

The inference unit 102 applies inference data 1 and inference data 2 outputted by the control unit 101 to the inference model, performs deep learning-based inference processing, and outputs an inference result. The inference result may be outputted to a storage inside the inference apparatus 100 or may be outputted to an external apparatus via a wide area network, such as the Internet.

A suitability determination unit 103 determines respective suitabilities of image data and sound data, which serve as input data for when the inference unit 102 performs the inference processing. The suitability determination unit 103 calculates evaluation information of the image data and the sound data and compares evaluation information with a threshold. The suitability determination unit 103 determines that input data whose evaluation information is greater than or equal to the threshold is suitable for the inference processing and determines that input data whose evaluation information is less than the threshold is not suitable (hereinafter, unsuitable) for the inference processing, and outputs a determination result to the control unit 101. A method of determining a suitability of input data will be described later in detail.

A characteristic information calculation unit 104 obtains characteristics of image data and sound data and calculates normalized characteristic values according to the characteristics. A method of calculating a characteristic value will be described later in detail.

The control unit 101 includes a processor, such as a CPU, and memories, such as a ROM and a RAM. The control unit 101 controls inference data to be outputted to the inference unit 102 based on characteristic values of image data and sound data. The control unit 101 decides substitute data for input data determined to be unsuitable by the suitability determination unit 103 based on the characteristic values of the image data and the sound data. When the suitability determination unit 103 determines that the image data and the sound data are suitable, the control unit 101 outputs the image data and the sound data as the inference data 1 and the inference data 2, respectively, to the inference unit 102. When the suitability determination unit 103 determines that the image data is suitable and the sound data is unsuitable, the control unit 101 outputs the image data and substitute data for the sound data as the inference data 1 and the inference data 2, respectively, to the inference unit 102. A method of controlling inference data will be described later in detail.

### <Configuration of Inference Unit 102>

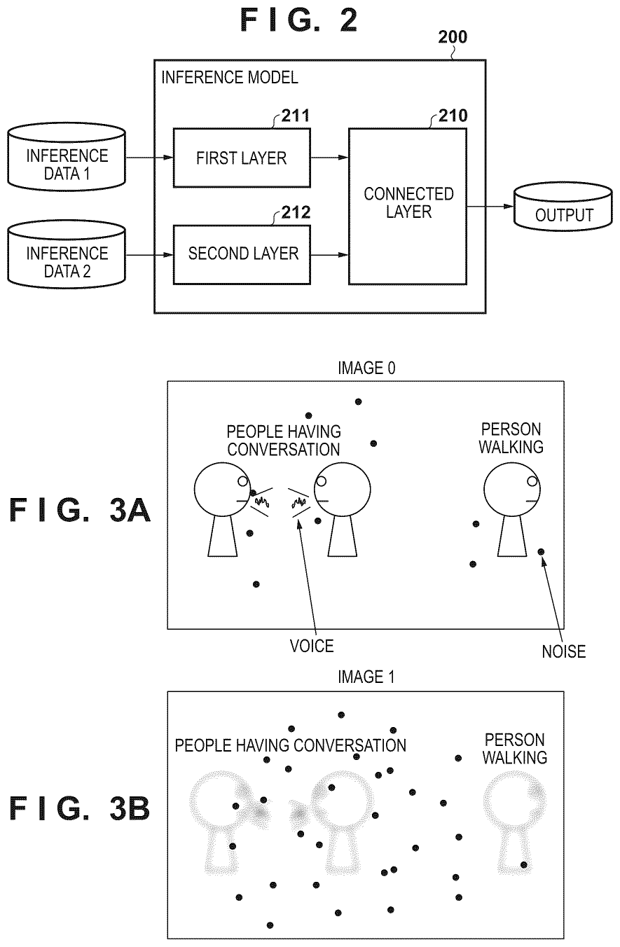

Next, a configuration and functions of the inference unit 102 according to the present embodiment will be described with reference to FIG. 2.

The inference unit 102 includes an inference model 200. The inference model 200 is constituted by a neural network, and in the present embodiment, is constituted by a convolutional neural network (CNN). An inference model of the present embodiment is not limited to a CNN and may be constituted by a neural network, such as a recurrent neural network (RNN) or a fully-connected neural network. A method of computation of a neural network is well known, and so, description will be omitted.

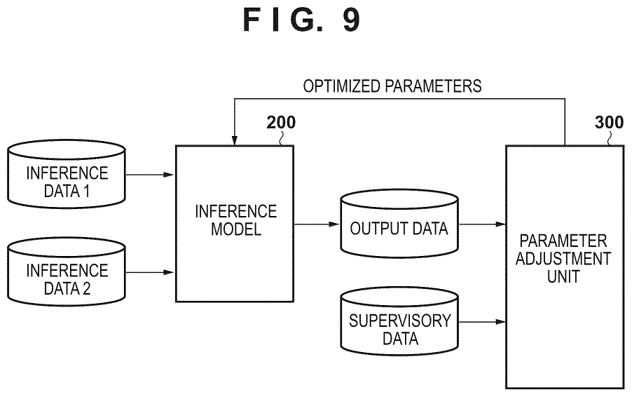

The deep learning-based inference processing in the inference unit 102 can be executed by a graphics processing unit (GPU). This is also true for processing for training the inference model 200, which will be described later in FIG. 9. The GPU is a processor capable of performing processing specialized for computer graphics computation and has a computational processing capability to perform matrix operations and the like necessary for deep learning in a short time. Regarding deep learning, the CPU of the control unit 101 and the GPU of the inference unit 102 may perform computation in cooperation, or one of the CPU of the control unit 101 and the GPU of the inference unit 102 may perform the computation.

The inference model 200 includes a first layer 211 which takes the inference data 1 outputted by the control unit 101 as input, a second layer 212 which takes the inference data 2 outputted by the control unit 101 as input, and a connected layer 210 which combines output of the first layer 211 and output of the second layer 212 and outputs a result of inference of a region of interest.

The first layer 211 extracts a feature related to the inference data 1. The first layer 211 extracts, for example, a likelihood of a person of interest, obtained from an image.

The second layer 212 extracts a feature related to the inference data 2. The second layer 212 extracts, for example, a likelihood of a person of interest, obtained from voice.

The connected layer 210 takes output of the first layer 211 and output of the second layer 212 as input, combines a feature outputted from the first layer 211 and a feature outputted from the second layer 212, and outputs an inference result.

### <Description of Image Data>

Next, image data to be inputted to the inference apparatus 100 according to the present embodiment will be described with reference to FIGS. 3A and 3B.

FIG. 3A illustrates an image 0, which includes people having a conversation and a person walking and has no blur but includes some image noise.

FIG. 3B illustrates an image 1, which has a high blur amount and includes more noise compared to the image 0.

Noise of an image according to the present embodiment is high-sensitivity noise generated due to a high ISO sensitivity at the time of capturing the image but is not limited thereto and may be long-exposure noise or the like generated when the image sensor generates heat.

Blurring of the image according to the present embodiment is caused by shaking of the camera or a movement of a subject at the time of capturing the image or is caused by a focus error but is not limited thereto and may be blurring that is attributable to an optical system at the time of capturing the image or the like.

A method of calculating a noise amount and a blur amount is well known, and thus, description thereof will be omitted.

### <Description of Audio Data>

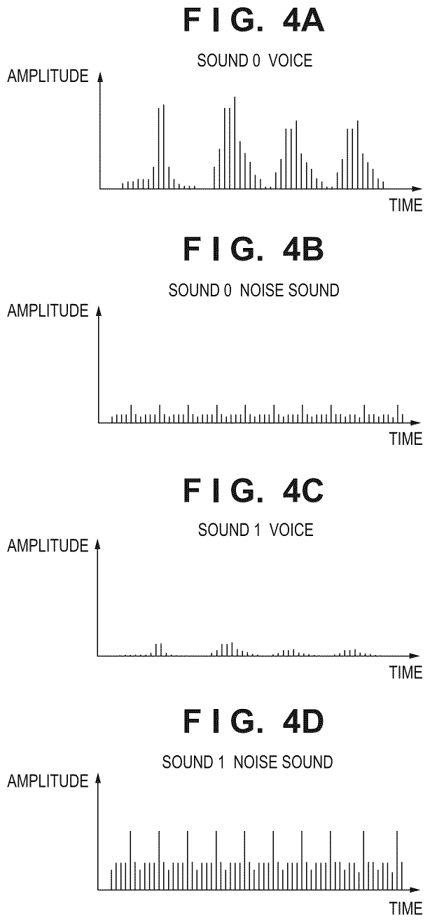

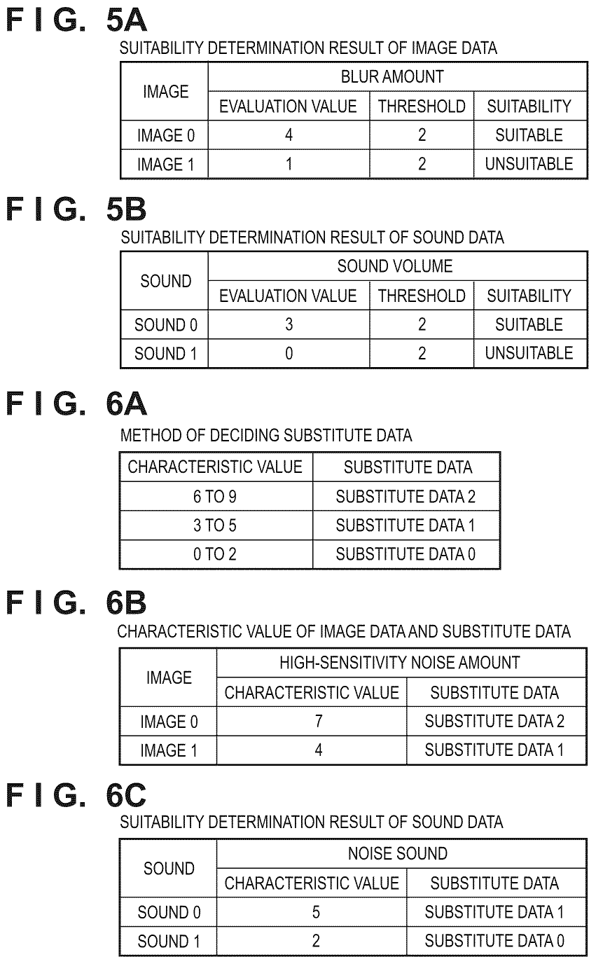

Next, sound data to be inputted to the inference apparatus 100 according to the present embodiment will be described with reference to FIGS. 4A to 4D.

FIG. 4A illustrates an audio waveform of sound 0 which is voice of people having a conversation, among pieces of sound data to be inputted to the inference apparatus 100.

FIG. 4B illustrates an audio waveform of noise sound of the sound 0, such as wind noise, among environmental sounds occurring around the inference apparatus 100.

FIG. 4C illustrates an audio waveform of sound 1 in which vocal volumes of people having a conversation are lower than those of the sound 0 of FIG. 4A and an amplitude of the audio is smaller than that of the sound 0.

FIG. 4D illustrates an audio waveform of noise sound of the sound 1 in which noise sound is louder than that of the sound 0 due to sounds of cars driving or the like among environmental sounds occurring around the inference apparatus 100.

Methods of calculating a sound volume and a noise amount are well known, and thus, description thereof will be omitted.

### <Result of Determining Suitability of Input Data>

Next, a method of determining respective suitabilities of image data and sound data by the suitability determination unit 103 according to the present embodiment will be described with reference to FIGS. 5A and 5B.

The suitability determination unit 103 calculates evaluation information for determining respective suitabilities of image data and sound data, which serve as pieces of input data, in a range of evaluation values from a minimum 0 to a maximum 4. In the present embodiment, a suitability of input data is determined with a threshold set to 2. The suitability determination unit 103 determines that the input data is suitable when an evaluation value is greater than or equal to 2 and determines that the input data is unusable when an evaluation value is less than 2.

In the present embodiment, the greater the evaluation value, the more suitable the data is for the inference processing, and the smaller the evaluation value, the less suitable the data is for the inference processing, and suitable data and unsuitable data are determined using the threshold of 2 as a reference. A method of determining a suitability of input data is not limited to the method described above and may be any method.

The suitability determination unit 103 determines a suitability of image data to be inputted based on a blur amount and determines a suitability of sound data to be inputted based on a sound volume.

Here, respective methods of calculating an evaluation value related to a blur amount of image data and an evaluation value related to a sound volume of sound data will be described.

First, the method of calculating an evaluation value of a blur amount of image data will be described.

In the present embodiment, people having a conversation are identified by recognizing subjects in an image, and a region of interest is thereby obtained. As a blur amount of image data increases, it becomes more difficult to identify people having a conversation, and so, a suitability is determined using a blur amount of image data as an evaluation value. For example, when a blur amount of image data that is so blurred that a person cannot be identified is assumed to be 100% and a blur amount of image data that is not blurred is assumed to be 0%, the greater the blur amount, the lower the evaluation value is set to be, and the smaller the blur amount, the higher the evaluation value is set to be. In the present embodiment, an evaluation value is set to be 0 to 4, respectively, for 20% intervals of a blur amount.

A threshold for a blur amount according to the present embodiment is a threshold for determining whether a person can be identified.

Next, the method of calculating an evaluation value of a sound volume of sound data will be described.

In the present embodiment, when recognizing a subject in an image, it is difficult to obtain voices of people having a conversation if a sound volume is small, and so, a suitability is determined by using a sound volume of sound data as an evaluation value. For example, when a sound volume of sound data in which there is no sound volume of a conversation at all is assumed to be 0% and a limit value of a sound volume of a sound pickup device, such as a microphone for obtaining audio, is assumed to be 100%, the lower the sound volume, the lower the evaluation value is set to be, and the higher the sound volume, the higher the evaluation value is set to be. In the present embodiment, an evaluation value is set to be 0 to 4, respectively, for 20% intervals of a sound volume. A threshold for a sound volume according to the present embodiment is a threshold for determining whether voice of people having a conversation can be identified. A configuration may be taken such so as to, when a conversation cannot be identified due to a sound volume being too loud, lower an evaluation value.

In the present embodiment, respective evaluation values are calculated based on a blur amount of image data and a sound volume of sound data, and respective suitabilities are determined based on the respective evaluation values, but luminance or high-sensitivity noise and noise sound, such as surrounding environmental sounds, may be used. A method of calculating an evaluation value is well known, and thus, description thereof will be omitted.

FIG. 5A illustrates a result of determining, for each of the image 0 and the image 1, which serve as input data, a suitability based on an evaluation value calculated from a blur amount and a threshold.

When the image 0 is inputted, the suitability determination unit 103, since the image 0 is not blurred, sets an evaluation value of a blur amount to 4 and, since the evaluation value is greater than or equal to the threshold of 2, determines that the image 0 is suitable. When the image 1 is inputted, the suitability determination unit 103, since the image 1 has a lot of blurring, sets an evaluation value to 1 and, since the evaluation value is less than the threshold of 2, determines that the image 1 is unsuitable.

FIG. 5B illustrates a result of determining, for each of the sound 0 and the sound 1, which serve as input data, a suitability based on a sound volume and a threshold.

When the sound 0 is inputted, the suitability determination unit 103 sets an evaluation value of a sound volume to 3 and, since the evaluation value is greater than or equal to the threshold of 2, determines that the sound 0 is suitable. When the sound 1 is inputted, the suitability determination unit 103, since an audio waveform can barely be obtained, sets an evaluation value to 0 and, since the evaluation value is less than the threshold of 2, determines that the sound 1 is unsuitable.

### <Characteristic Value of Input Data and Method of Deciding Substitute Data>

Next, a method of calculating characteristic information of input data and a method of deciding substitute data will be described with reference to FIG. 6.

FIG. 6A illustrates a characteristic value of input data and substitute data. The characteristic information calculation unit 104 calculates a characteristic value, with a characteristic that can be obtained from input data being a minimum 0 to a maximum 9. The control unit 101 decides substitute data to be substitute data 2 when a characteristic value is 6 to 9, substitute data 1 when a characteristic value is 3 to 5, and substitute data 0 when a characteristic value is 0 to 2.

In the present embodiment, a characteristic of a high-sensitivity noise amount in image data is obtained, and a normalized characteristic value is calculated.

Here, a method of normalization according to the characteristic of a high-sensitivity noise amount in image data will be described.

The more high-sensitivity noise there is in image data, the more difficult it is to identify people having a conversation as people of interest. For example, when a noise amount of image data in which there is so much high-sensitivity noise that a person cannot be identified is assumed to be 100% and a noise amount of an image in which there is no noise at all is assumed to be 0%, the greater the high-sensitivity noise amount, the lower the characteristic value is set to be, and the smaller the high-sensitivity noise amount, the higher the characteristic value is set to be. In the present embodiment, a characteristic value is calculated to be 0 to 9, respectively, for 10% noise amount intervals.

FIG. 6B illustrates respective characteristic values of high-sensitivity noise in the image 0 and the image 1 for when the image 0 and the image 1 of FIGS. 3A and 3B are used as input data, and substitute data decided based on the respective characteristic values. In the present embodiment, high-sensitivity noise is given as an example of a characteristic value calculated by the characteristic information calculation unit 104, but an SN ratio, a luminance, a blur amount, or the like in image data may be used.

Respective pieces of information used for calculation by the suitability determination unit 103 and the characteristic information calculation unit 104 may be the same. Information in that case is a blur amount, high-sensitivity noise, or the like according to the present embodiment. For example, in the present embodiment, a configuration may be taken such that the suitability determination unit 103 and the characteristic information calculation unit 104 calculate an evaluation value and a characteristic value, both using a blur amount.

When the image 0 is inputted, the characteristic information calculation unit 104 calculates a characteristic value of high-sensitivity noise to be 7, and since the characteristic value is 6 to 9, the control unit 101 decides substitute data to be the substitute data 2. When the image 1 is inputted, the characteristic information calculation unit 104 calculates a characteristic value of high-sensitivity noise to be 4, and since the characteristic value is 3 to 5, the control unit 101 decides substitute data to be the substitute data 1.

FIG. 6C illustrates respective characteristic values of noise sound, which is environmental sounds around the inference apparatus 100, for when the sound 0 and the sound 1 in FIGS. 4A to 4D are used as input data, and substitute data decided by the control unit 101 based on the respective characteristic values.

When the sound 0 is inputted, the characteristic information calculation unit 104 calculates a characteristic value of noise sound to be 5, and since the characteristic value is 3 to 5, the control unit 101 decides substitute data to be the substitute data 1. When the sound 1 is inputted, the characteristic information calculation unit 104 calculates a characteristic value of noise sound to be 2, and since the characteristic value is 0 to 2, the control unit 101 decides substitute data to be the substitute data 0.

The normalization method is not limited to the method described above and may be any method so long as a quantified characteristic value can be calculated based on a certain criterion. In the present embodiment, 10 levels of characteristic values are set from 0 to 9, and three types of substitute data are set, but the present disclosure is not limited thereto.

A configuration may be taken such that the characteristic information calculation unit 104 calculates a characteristic value only for data determined to be suitable by the suitability determination unit 103. This makes it possible to reduce time required for computation processing of the characteristic information calculation unit 104.

### <Method of Deciding Inference Data>

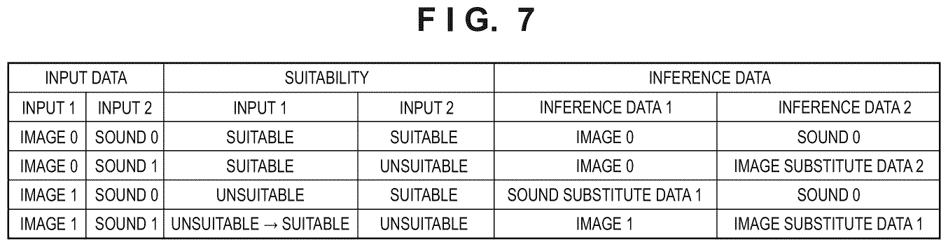

Next, a method of deciding inference data to be outputted from the control unit 101 to the inference unit 102 based on a suitability determination result of the suitability determination unit 103 and substitute data decided by the control unit 101 will be described with reference to FIG. 7.

In FIG. 7, when the image 0 is inputted as the input 1 and the sound 0 is inputted as the input 2, since both pieces of input data are suitable, the control unit 101 outputs the image 0 as the inference data 1 and the sound 0 as the inference data 2.

When the image 0 is inputted as the input 1 and the sound 1 is inputted as the input 2, since the image 0 is suitable but the sound 1 is unsuitable, the control unit 101 outputs the image 0 as the inference data 1 and, in place of the sound 1, image substitute data 2 as the inference data 2.

When the image 1 is inputted as the input 1 and the sound 0 is inputted as the input 2, since the image 1 is unsuitable but the sound 0 is suitable, the control unit 101 outputs sound substitute data 1 as the inference data 1 and the sound 0 as the inference data 2.

When the image 1 is inputted as the input 1 and the sound 1 is inputted as the input 2, since both pieces of input data are unsuitable, the suitability determination unit 103 compares once again respective evaluation values for when respective suitabilities of the image 1 and the sound 1 were determined, and changes the suitability determination result of the image 1 whose evaluation value is higher to suitable. The control unit 101 outputs the image 1 as the inference data 1 and image substitute data 1 as the inference data 2.

### <Processing for Controlling Inference Data>

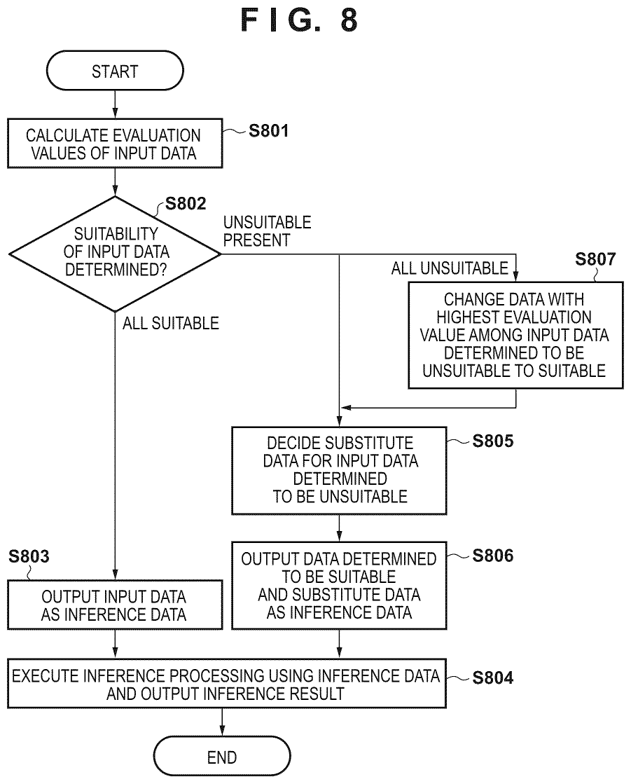

Next, processing for controlling inference data by the inference apparatus 100 according to the present embodiment will be described with reference to FIG. 8.

The processing of FIG. 8 is realized by the control unit 101 executing a program stored in a memory and is started by image data and sound data being inputted to the inference apparatus 100.

In step S801, the suitability determination unit 103 calculates evaluation values of input data.

In step S802, the suitability determination unit 103 compares the evaluation values calculated in step S801 with a threshold. The suitability determination unit 103 determines that input data is suitable when it is determined that an evaluation value is greater than or equal to the threshold and determines that input data is unsuitable when it is determined to be less than the threshold. When it is determined that all pieces of input data are suitable, the suitability determination unit 103 advances the processing to step S803. The suitability determination unit 103 advances the processing to step S805 when it is determined that some pieces of input data are unsuitable and advances the processing to step S807 when it is determined that all pieces of input data are unsuitable.

In step S803, the control unit 101 outputs the image data as inference data 1 and the sound data as inference data 2.

In step S804, the inference unit 102 performs the inference processing using the inference data 1 and the inference data 2 outputted from the control unit 101, outputs an inference result, and terminates the processing.

In step S805, the control unit 101 decides substitute data for the input data determined to be unsuitable in step S802 based on a characteristic value of the input data determined to be suitable in step S802.

In step S806, the control unit 101 outputs the input data determined to be suitable in step S802 as the inference data 1 and the substitute data decided in step S805 as the inference data 2, and advances the processing to step S804.

In step S807, the suitability determination unit 103 changes a suitability determination result of a piece of input data with the highest evaluation value among the pieces of input data determined to be unsuitable to suitable and advances the processing to step S805.

According to the first embodiment, when it is determined that some of the input data are unsuitable, by setting substitute data decided based on a characteristic value of data determined to be suitable as inference data in place of the input data determined to be unsuitable, it is possible to improve inference accuracy compared to inference processing in which input data determined unsuitable is used.

Further, when it is determined that all pieces of input data are suitable, since the pieces of input data determined to be suitable are set as inference data, it is possible to prevent a decrease in inference accuracy.

When it is determined that all pieces of input data are unsuitable, by changing a suitability of a piece of input data with the highest evaluation value among the pieces of input data determined to be unsuitable to suitable and setting substitute data decided based on a characteristic value of the input data with the highest evaluation value as inference data in place of other input data determined to be unsuitable, it is possible to improve inference accuracy compared to inference processing in which all pieces of input data determined to be unsuitable are used.

### <Processing for Training Inference Model>

Next, processing for training the inference model 200 of FIG. 2 will be described with reference to FIG. 9.

Regarding the inference model 200 of the inference unit 102 according to the present embodiment, training processing is executed in advance by an information processing apparatus, such as a personal computer (PC), that is different from the inference apparatus 100.

The processing for training the inference model 200 can be the same processing as that of the inference unit 102 of the inference apparatus 100.

The processing for training the inference model 200 according to the present embodiment is processing for optimizing parameters of the inference model 200 using training data prepared in advance and updating parameters of the inference model 200 to the optimized parameters. The training data includes input data and supervisory data. The input data is inputted to the inference model 200, and a parameter adjustment unit 300 optimizes the parameters of the inference model 200 so as to minimize a deviation between output data of the inference model 200 and the supervisory data as much as possible. The inference model 200 obtains the optimized parameters from the parameter adjustment unit 300 and updates existing parameters.

The training data includes training input data and supervisory data. The training input data is a data set prepared by combining plural data and, in the present embodiment, is the inference data 1 and the inference data 2. A first data set is a data set in which image data and sound data determined to be suitable by the suitability determination unit 103 are combined. A second data set is a data set in which image data determined to be suitable by the suitability determination unit 103 and substitute data decided based on a characteristic value of the image data are combined. A third data set is a data set in which sound data determined to be suitable by the suitability determination unit 103 and substitute data decided based on a characteristic value of the sound data are combined.

The training supervisory data is output data which is outputted according to prior training processing in which training input data has been used and, in the present embodiment, is data of a region of interest outputted according to training processing in which image data and sound data, which serve as inference data, have been used as input data.

By using the training data described above for the processing for training the inference model 200, the training processing is performed so as to be limited to input data for which input data and substitute data decided based on a characteristic value of the input data have been combined, and thereby, it is possible to reduce the number of parameters and the data amount.

The training input data is not limited to image data and sound data and may be any data so long as an evaluation value and a characteristic value of the data can be obtained.

Further, the training input data need not only be two (the inference data 1 and the inference data 2); there may be three or more input data, and in that case, a configuration may be taken such that the inference model 200 includes processing layers corresponding to plural input data and executes a plurality of training processes.

An algorithm of processing for training a neural network, such as back propagation, is well known, and so, description thereof will be omitted.

### Second Embodiment

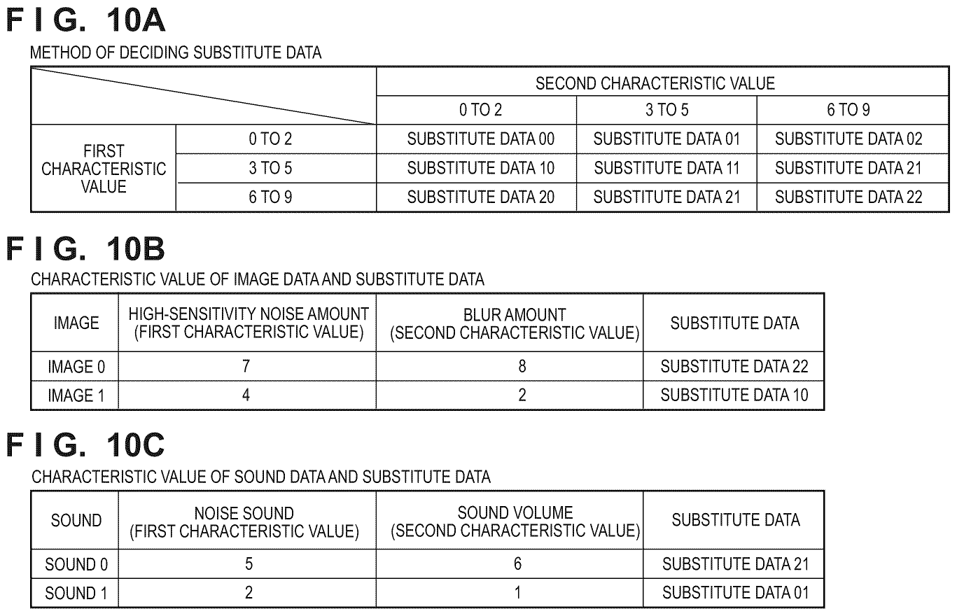

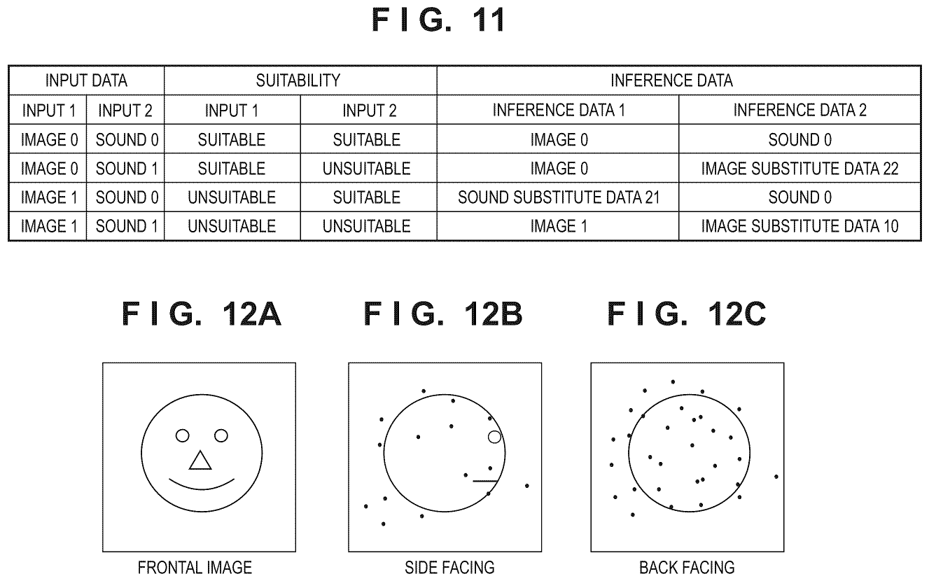

Next, a second embodiment will be described with reference to FIGS. 10A to 10C and FIG. 11.

The second embodiment is different from the first embodiment in a method by which the characteristic information calculation unit 104 calculates a characteristic value and a method by which the control unit 101 decides substitute data.

A configuration of the inference apparatus 100 and configurations and functions of the inference unit 102 and the suitability determination unit 103 according to the second embodiment are similar to those of the first embodiment.

The characteristic information calculation unit 104 obtains a plurality of characteristics from each of image data and sound data and calculates a plurality of normalized characteristic values, each according to a respective characteristic.

The control unit 101 decides substitute data associated with a plurality of characteristic values based on a plurality of characteristic values of each of image data and sound data and controls inference data to be outputted to the inference unit 102 based on a suitability determination result.

### <Characteristic Value of Input Data and Method of Deciding Substitute Data>

Next, the method by which the characteristic value calculation unit 104 calculates two characteristic values from one piece of input data and the control unit 101 decides substitute data based on the two characteristic values in the second embodiment will be described with reference to FIGS. 10A to 10C.

FIG. 10A illustrates a first characteristic value and a second characteristic value calculated from one piece of input data and substitute data decided by the control unit 101.

For example, when the first characteristic value is in a range of 0 to 2 and the second characteristic value is in a range of 0 to 2, it is decided that substitute data is substitute data 00. Further, when the first characteristic value is in a range of 0 to 2 and the second characteristic value is in a range of 3 to 5, it is decided that substitute data is substitute data 01.

In this way, one piece of substitute data is decided based on a plurality of characteristic values.

FIG. 10B illustrates substitute data decided by the control unit 101 based on the first characteristic value calculated from a high-sensitivity noise amount of image data and the second characteristic value calculated from a blur amount of the image data, according to the relationship of FIG. 10A.

When the image 0 is inputted, the characteristic information calculation unit 104 calculates a characteristic value of a high-sensitivity noise amount to be 7 and a characteristic value of a blur amount to be 8, and the control unit 101 decides substitute data for the image 0 to be substitute data 22.

When the image 1 is inputted, the characteristic information calculation unit 104 calculates a characteristic value of a high-sensitivity noise amount to be 4 and a characteristic value of a blur amount to be 2, and the control unit 101 decides substitute data for the image 1 to be substitute data 10.

FIG. 10C illustrates substitute data decided by the control unit 101 based on the first characteristic value calculated from noise sound of sound data and the second characteristic value calculated from a sound volume of the sound data, according to the relationship of FIG. 10A.

When the sound 0 is inputted, the characteristic information calculation unit 104 calculates a characteristic value of noise sound to be 5 and a characteristic value of a sound volume to be 6, and the control unit 101 decides substitute data for the sound 0 to be substitute data 21.

When the sound 1 is inputted, the characteristic information calculation unit 104 calculates a characteristic value of noise sound to be 2 and a characteristic value of a sound volume to be 1, and the control unit 101 decides substitute data for the sound 1 to be the substitute data 01.

### <Method of Deciding Inference Data>

Next, a method by which the control unit 101 decides inference data based on a suitability determination result of the suitability determination unit 103 and substitute data decided by the characteristic information calculation unit 104 in the second embodiment will be described with reference to FIG. 11.

Assume that the suitability determination result according to the first embodiment is used for a suitability determination result of input data according to the second embodiment.

FIG. 11 is a diagram illustrating a method by which, when the image 0 or the image 1 is inputted as the input 1 and the sound 0 or the sound 1 is inputted as the input 2 to the inference apparatus 100, the control unit 101 decides inference data based on suitability determination results of FIGS. 5A and 5B and substitute data decided using FIGS. 10A to 10C.

When the image 0 is inputted as the input 1 and the sound 0 is inputted as the input 2, since both suitability determination results are suitable, the control unit 101 outputs the image 0 as the inference data 1 and the sound 0 as the inference data 2.

When the image 0 is inputted as the input 1 and the sound 1 is inputted as the input 2, since the image 0 is suitable but the sound 1 is unsuitable, the control unit 101 outputs the image 0 as the inference data 1 and, in place of the sound 1, image substitute data 22 as the inference data 2.

When the image 1 is inputted as the input 1 and the sound 0 is inputted as the input 2, since the image 1 is unsuitable but the sound 0 is suitable, the control unit 101 outputs the sound 0 as the inference data 2 and, in place of the image 1, sound substitute data 21 as the inference data 1.

When the image 1 is inputted as the input 1 and the sound 1 is inputted as the input 2, since both suitability determination results are unsuitable, the suitability determination unit 103 compares respective evaluation values for when respective suitabilities of the image 1 and the sound 1 were determined, and changes the suitability determination result of the image 1 whose evaluation value is higher to suitable. The control unit 101 outputs the image 1 as the inference data 1 and, in place of the sound 1, image substitute data 10 as the inference data 2.

According to the second embodiment, by executing the inference processing using input data and substitute data decided based on a plurality of characteristic values, it is possible to further improve inference accuracy compared to the first embodiment.

### <Processing for Training Inference Model>

Next, processing for training an inference model according to the second embodiment will be described.

Regarding the processing for training the inference model 200 according to the present embodiment, training input data is different from the training data used in the training processing according to the first embodiment, and the rest are the same as in the first embodiment, and so, description thereof will be omitted.

The training input data is a data set prepared by combining a plurality of pieces of data and, in the present embodiment, is the inference data 1 and the inference data 2. A first data set is a data set in which image data and sound data determined to be suitable by the suitability determination unit 103 are combined. A second data set is a data set in which image data determined to be suitable by the suitability determination unit 103 and substitute data decided based on a plurality of characteristic values of the image data are combined. A third data set is a data set in which sound data determined to be suitable by the suitability determination unit 103 and substitute data decided based on a plurality of characteristic values of the sound data are combined.

By using the training data described above for the processing for training the inference model 200, the training processing is performed so as to be limited to input data for which input data and substitute data decided based on a plurality of characteristic values of the input data have been combined, and thereby, it is possible to reduce the number of parameters and a data amount. The more the training is performed with a large amount of training input data prepared, the higher the effect of reducing the data amount. The training input data is not limited to image data and sound data and may be any piece of data so long as an evaluation value and a characteristic value of the data can be obtained.

Further, the training input data need not only be two, which are the inference data 1 and the inference data 2, and may be three or more pieces of input data, and in that case, a configuration may be taken such that the inference model 200 includes processing layers corresponding to a plurality of pieces of input data and executes a plurality of training processes.

An algorithm of processing for training a neural network, such as back propagation, is well known, and so, description thereof will be omitted.

### Third Embodiment

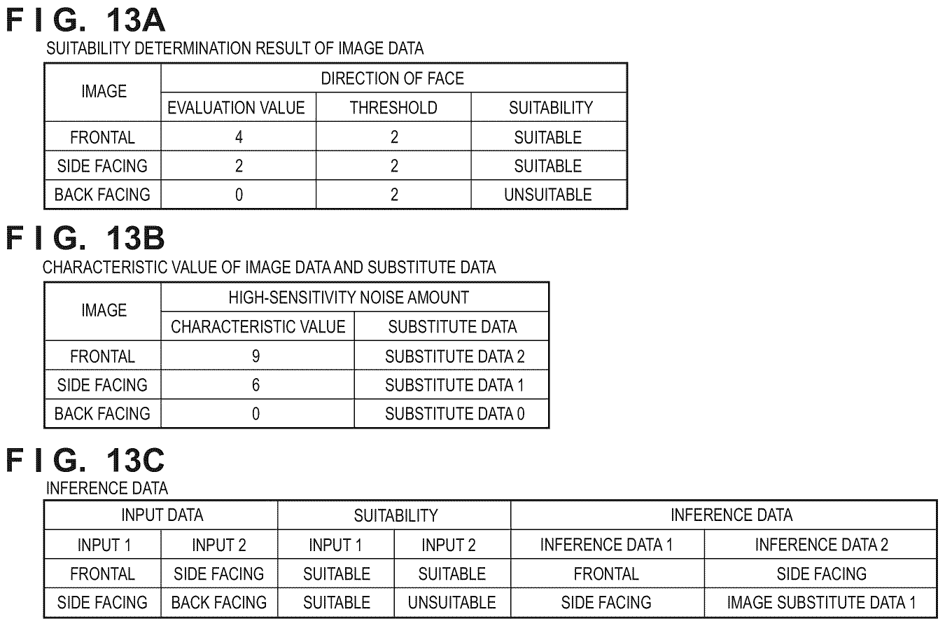

Next, a third embodiment will be described with reference to FIGS. 12A to 12C and FIGS. 13A to 13C.

The third embodiment is different from the first embodiment in image data, which serves as input data.

A configuration of the inference apparatus 100 and configurations and functions of the inference unit 102 and the characteristic information calculation unit 104 according to the third embodiment are similar to those of the first embodiment.

The inference apparatus 100 according to the third embodiment identifies a person by performing inference processing using images in which a subject has been captured from different directions or angles as pieces of input data. Both the inference data 1 and the inference data 2 are input image data and output data is particular person information. The particular person information to be outputted may be image or text information and may be any information so long as a person can be identified.

### <Description of Input Data>

Next, image data to be inputted to the inference apparatus 100 according to the third embodiment will be described with reference to FIGS. 12A to 12C.

FIGS. 12A to 12C illustrate images of a person's face captured from different directions or angles.

FIG. 12A illustrates a frontal image captured from the front.

FIG. 12B illustrates a side facing image captured directly from the side and includes more high-sensitivity noise than the frontal image of FIG. 12A.

FIG. 12C illustrates a back facing image captured directly from the back and includes more high-sensitivity noise than the side facing image of FIG. 12B.

In the third embodiment, the suitability determination unit 103 calculates an evaluation value according to an amount of information on facial features, such as the eyes, nose, and mouth, in the face of a person in an image.

For example, a state in which the face is facing directly forward and the eyes, nose, mouth, and the like are all included in an image is assumed to be 100%, and a back facing state in which the eyes, nose, mouth, and the like are all not included in an image is assumed to be 0%, and an evaluation value is calculated in a range of values from 0 to 4 according to a feature information amount. Then, a suitability of data is determined by comparing the evaluation value with a threshold.

Here, a method by which the suitability determination unit 103 calculates respective evaluation values of pieces of image data when images of FIGS. 12A to 12C are inputted will be described.

FIG. 12A illustrates a frontal image, and since the image includes all of the eyes, nose, mouth, and the like, an evaluation value is calculated to be 4.

FIG. 12B is a side facing image, and since an amount of information on features, such as the eyes, nose, and mouth, is about 50% compared to the frontal image, an evaluation value is calculated to be 2.

FIG. 12C is a back facing image, and since the image does not include any of the eyes, nose, mouth, and the like, an evaluation value is calculated to be 0.

### <Method of Deciding Inference Data>

Next, a method by which the control unit 101 decides inference data based on a suitability determination result of the suitability determination unit 103 and substitute data decided by the characteristic information calculation unit 104 in the third embodiment will be described with reference to FIGS. 13A to 13C.

FIG. 13A illustrates an evaluation value and a suitability determination result for each piece of input data.

When the frontal image is inputted, an evaluation value is 4, and since the evaluation value is greater than or equal to a threshold of 2, the frontal image is determined to be suitable. When the side facing image is inputted, an evaluation value is 3, and since the evaluation value is greater than or equal to the threshold of 2, the side facing image is determined to be suitable. When the back facing image is inputted, an evaluation value is 0, and since the evaluation value is less than the threshold of 2, the back facing image is determined to be unsuitable.

FIG. 13B illustrates substitute data decided based on a characteristic value calculated for a respective piece of input data. In the present embodiment, high-sensitivity noise is calculated as a characteristic value and substitute data is decided based on the characteristic value.

When the frontal image is inputted, the characteristic information calculation unit 104 calculates a characteristic value to be 9, and the control unit 101 decides substitute data to be 2. When the side facing image is inputted, the characteristic information calculation unit 104 calculates a characteristic value to be 6, and the control unit 101 decides substitute data to be 1. When the back facing image is inputted, the characteristic information calculation unit 104 calculates a characteristic value to be 0, and the control unit 101 decides substitute data to be 0.

FIG. 13C is a diagram illustrating a method by which, when the frontal image or the side facing image is inputted as the input 1 and the side facing image or the back facing image is inputted as the input 2 to the inference apparatus 100, the control unit 101 decides the inference data 1 and the inference data 2 based on the suitability determination result of FIG. 13A and substitute data decided using FIG. 13B.

When the frontal image is inputted as the input 1 and the side facing image is inputted as the input 2, since both are suitable, the control unit 101 outputs the frontal image as the inference data 1 and the side facing image as the inference data 2.

When the side facing image is inputted as the input 1 and the back facing image is inputted as the input 2, since it is determined that the back facing image is unsuitable, the control unit 101 outputs the side facing image as the inference data 1 and image substitute data 1 as the inference data 2.

According to the third embodiment, when respective feature information amounts of some pieces of input data are small, by calculating evaluation values based on feature information amounts, determining respective suitabilities of pieces of data, and using substitute data decided based on a characteristic values of data determined to be suitable for the inference processing in place of the data determined to unsuitable, it is possible to improve inference accuracy compared to inference processing in which data determined to be unsuitable is used.

### Fourth Embodiment

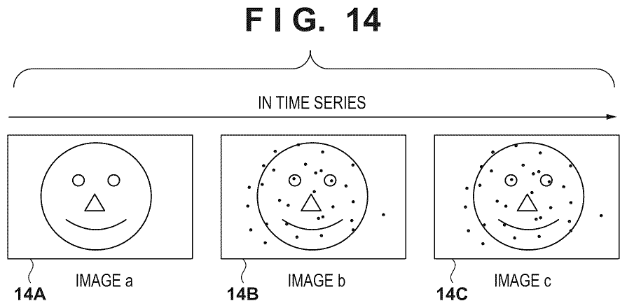

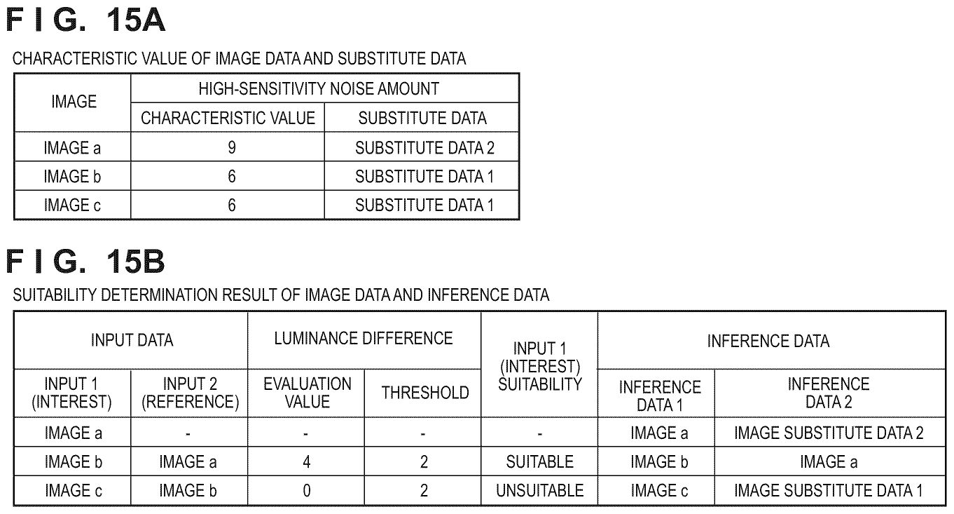

Next, a fourth embodiment will be described with reference to FIG. 14 and FIGS. 15A and 15B.

The fourth embodiment is different from the first embodiment in image data, which serves as input data.

A configuration of the inference apparatus 100 and configurations and functions of the inference unit 102 and the characteristic information calculation unit 104 according to the fourth embodiment are similar to those of the first embodiment.

The inference apparatus 100 according to the fourth embodiment performs processing for enhancing the image quality of an image of interest which succeeds a preceding image, which serves as a reference image, in a plurality of consecutively captured pieces of image data. The most recent image data, which serves as an image of interest, is inputted as the input 1, image data of an immediately preceding frame, which serves as a reference image, is inputted as the input 2, and output data is image data after image quality enhancement has been performed on the image of interest.

Image quality enhancement is noise reduction processing, and for example, it is possible to remove noise with higher accuracy by performing noise reduction processing using a plurality of pieces of data. Although there are a plurality of methods for image quality enhancement processing, they are all well known, and so, description thereof will be omitted.

### <Description of Input Data>

Next, image data to be inputted to the inference apparatus 100 according to the fourth embodiment will be described with reference to FIG. 14.

Images. 14A, 14B, 14C illustrate images captured consecutively in time series.

Image 14A illustrates an image a in which a person is positioned in the center of an image.

Image 14B illustrates an image b of a frame following the image a, and although the position of the person's face is the same as that of the image a, there is some high-sensitivity noise.

Image 14C illustrates an image c of a frame following that of the image b and, although the position of the person's face is the same as that of the image a, illustrates an image for when a flash was emitted.

The suitability determination unit 103 calculates a difference between an image of interest and a reference image for pieces of continuously captured image data and determines a suitability according to a result of comparing the difference with a threshold. In the fourth embodiment, a difference between an image of interest and a reference image is assumed to be a luminance difference.

A difference between an image of interest and a reference image may be calculated based on an average or variance of a predetermined region. In that case, the difference between the images may be calculated after a motion between the images has been predicted and the images have been aligned.

### <Method of Deciding Inference Data>

Next, a method by which the control unit 101 decides inference data to be outputted to the inference unit 102 based on a suitability determination result of the suitability determination unit 103 and substitute data decided by the characteristic information calculation unit 104 will be described with reference to FIGS. 15A and 15B.

FIG. 15A illustrates respective characteristic values of high-sensitivity noise calculated by the characteristic information calculation unit 104 from the image a, the image b, and the image c, and substitute data decided by the control unit 101 from the respective characteristic values.

Since there is no high-sensitivity noise in the image a, the characteristic information calculation unit 104 sets a characteristic value to be 9, and the control unit 101 decides substitute data to be substitute data 2 based on the characteristic value.

Since there is some high-sensitivity noise in the images b and c, the characteristic information calculation unit 104 sets respective characteristic values to be 6, and the control unit 101 decides respective pieces of substitute data to be substitute data 1.

A characteristic value of high-sensitivity noise is calculated using a method similar to that of the first embodiment, and the greater the high-sensitivity noise amount, the lower the characteristic value is calculated to be, and the smaller the high-sensitivity noise amount, the higher the characteristic value is calculated to be.

FIG. 15B illustrates, when the image a, the image b, and the image c are inputted in time series in that order as the input 1, which is an image of interest, and the input 2, which is a reference image, a suitability determined by the suitability determination unit 103 based on an evaluation value of a luminance difference between the images, and substitute data decided by the control unit 101 based on a suitability determination result and a characteristic value. In the present embodiment, a suitability is determined with the threshold being set to 2.

When the image a is inputted, since there is no reference image, the suitability determination unit 103 does not perform suitability determination, and the control unit 101 outputs the image a as the inference data 1 and image substitute data 2 as the inference data 2.

When the image b is inputted as the input 1 and the image a is inputted as the input 2, the suitability determination unit 103, since there is no luminance difference between the image b and the image a, sets an evaluation value of the image b to be 4 and, since the evaluation value is greater than or equal to the threshold of 2, determines that the image b is suitable. The control unit 101 outputs the image b as the inference data 1 and the image a as the inference data 2. In that case, since a luminance difference between an image of interest and a reference image is small, it is possible to reduce noise as intended and enhance the image quality of the image.

When the image c is inputted as the input 1 and the image b is inputted as the input 2, since the image c has a high luminance due to the flash and a luminance difference from the image b is large, inference accuracy decreases when image quality enhancement processing is performed on the inputted image data, and it is not possible to reduce noise as intended. Therefore, the suitability determination unit 103, since the luminance difference between the image c and the image b is large, sets an evaluation value of the image c to be 0 and, since the evaluation value is less than the threshold of 2, determines that the image c is unsuitable. The control unit 101 outputs image substitute data 1 as the inference data 1 and the image b as the inference data 2.

According to the fourth embodiment, when respective luminance of some pieces of image data captured consecutively is high, by determining a piece of data whose luminance difference from a preceding or succeeding piece of image data is large to be unsuitable and using substitute data decided based on data determined to be suitable in the inference processing instead of data determined to be unsuitable, it is possible to improve inference accuracy compared to inference processing in which data determined to be unsuitable is used.

### Fifth Embodiment

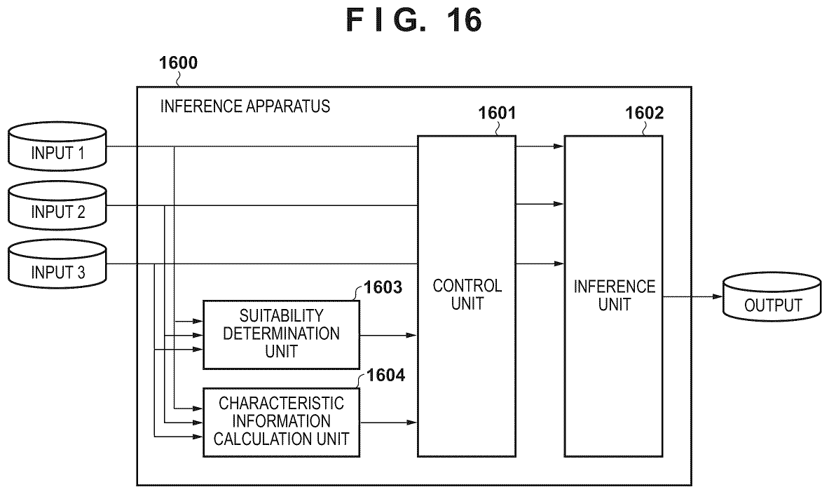

Next, a fifth embodiment will be described with reference to FIGS. 16 to 19.

In the fifth embodiment, parts different from the first to fourth embodiments will be mainly described, and description will be omitted for parts that are the same as or similar to the first to fourth embodiments.

### <Device Configuration>

First, a configuration and functions of an inference apparatus 1600 according to the fifth embodiment will be described with reference to FIG. 16.

Parts different from the first embodiment is processing of each unit and that input 3 has been added.

In the fifth embodiment, the inference apparatus 1600 takes image data as the input 1, image data as the input 2, and sound data as the input 3 and outputs, as an inference result, a region focusing on people who are having a conversation in an image. The plural input data is not limited to three types of data and may be more than three types of data.

Examples of input data according to the fifth embodiment are the image 0, the image 1, and the sound 0 described in FIGS. 3A and 3B and FIGS. 4A to 4D and sound 2. The sound 2 is the same sound source as the sound 1 according to the first embodiment and is data whose amplitude is greater than that of the sound 1.

An inference unit 1602 applies inference data 1, inference data 2, and inference data 3 outputted by a control unit 1601 to an inference model, performs deep learning-based inference processing, and outputs an inference result.

A suitability determination unit 1603 calculates two evaluation values for determining suitabilities of image data and sound data for respective pieces of data of the input 1, the input 2, and the input 3 and determines the suitabilities by comparing the evaluation values with two thresholds. A method of determining a suitability by comparison with a first threshold is similar to that of the first embodiment, and input data whose evaluation value is greater than or equal to the first threshold is determined to be suitable and input data whose evaluation value is less than the first threshold is determined to be unsuitable.

Regarding a method of determining a suitability by comparison with a second threshold, when a difference between input data with the highest evaluation value and input data with the next highest evaluation value is greater than or equal to the second threshold, it is determined that the input data with the highest evaluation value is suitable and other pieces of input data are unsuitable. When the difference between evaluation values is less than the second threshold, it is determined that all pieces of input data are suitable, and a suitability determined result is outputted to the control unit 1601. The methods of determining a suitability will be described later in detail.

A characteristic information calculation unit 1604 obtains a plurality of characteristics of each of piece of data of the input 1, the input 2, and the input 3 and calculates a plurality of normalized characteristic values, each according to a respective characteristic.

The control unit 1601 controls inference data to be outputted to the inference unit 1602 based on a suitability determination result and characteristic values of each piece of data of the input 1, the input 2, and the input 3.

When it is determined that one piece of input data is suitable and two pieces of input data are unsuitable among three pieces of data to be inputted as the input 1, the input 2, and the input 3, the control unit 1601 decides substitute data of each characteristic value based on a first characteristic value and a second characteristic value of the one piece of data determined to be suitable, and outputs, to the inference unit 1602, the one piece of data determined to be suitable and the two piece of substitute data as inference data 1, inference data 2, and inference data 3. When it is determined that two pieces of input data are suitable and one piece of input data is unsuitable among pieces of data to be inputted as the input 1, the input 2, and the input 3, the control unit 1601 compares characteristic values of the two pieces of data determined to be suitable and outputs, to the inference unit 1602, substitute data decided based on the highest characteristic value as inference data in place of the one piece of data determined to be unsuitable.

A configuration may be taken so as to, when there are a plurality of pieces of data determined to be unsuitable, decide substitute data in order from data with the highest characteristic value among pieces of data determined to be suitable and output substitute data as inference data for the number of pieces of data determined to be unsuitable. A method of controlling inference data will be described later in detail.

### <Configuration of Inference Unit 1602>

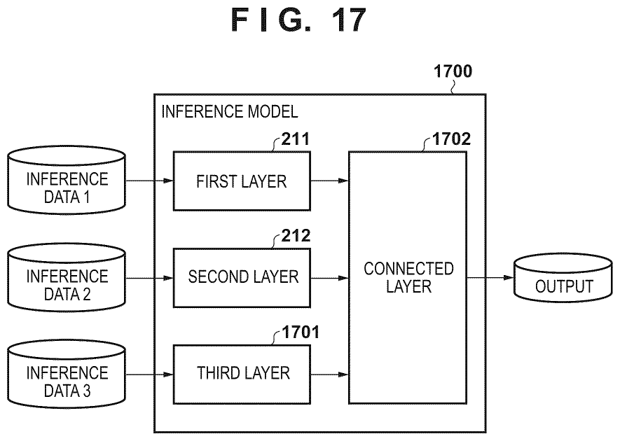

Next, a configuration and functions of the inference unit 1602 according to the fifth embodiment will be described with reference to FIG. 17.

What is different from the first embodiment is that the inference data 3 has been added and a third layer 1701 corresponding to the inference data 3 has been added to an inference model 1700. Regarding other configurations, configurations that are the same as in FIG. 2 of the first embodiment are denoted using the same reference numerals, and description will be omitted.

The inference model 1700 includes a first layer 211 which takes the inference data 1 as input, a second layer 212 which takes the inference data 2 as input, a third layer 1711 which takes the inference data 3 as input, and a connected layer 1702 which combines output of the first layer 211, output of the second layer 212, and output of the third layer 1701 and outputs a result of inference of a region of interest.

### <Method of Deciding Inference Data>

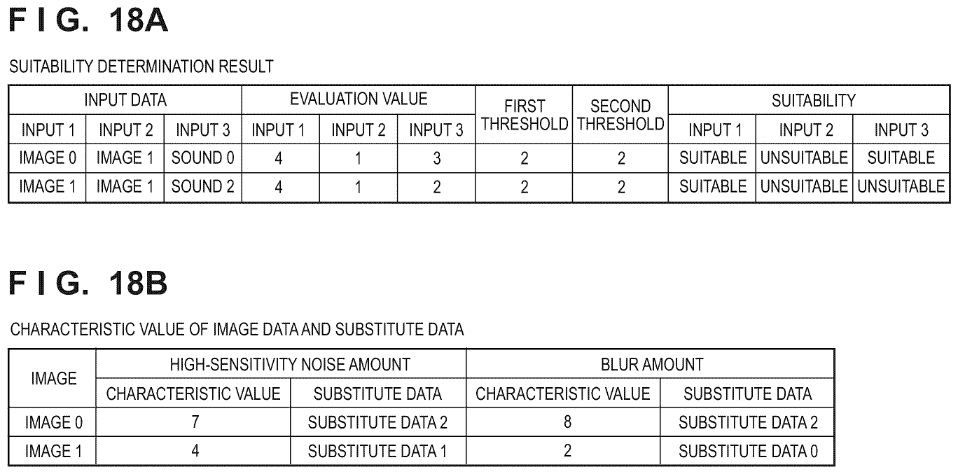

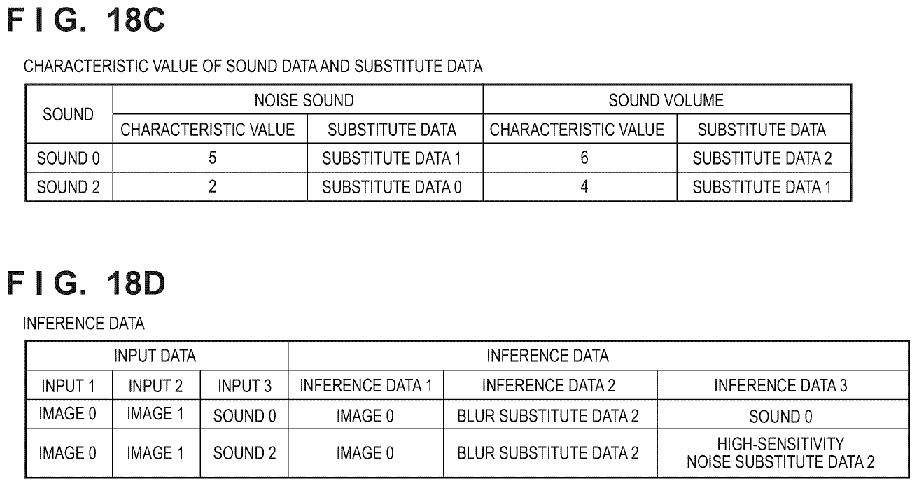

Next, a method by which the control unit 1601 decides inference data based on a suitability determination result of the suitability determination unit 1603 and characteristic information of the characteristic information calculation unit 1604 will be described with reference to FIGS. 18A to 18D.

FIG. 18A illustrates a suitability determination result for when the image 0 is inputted as the input 1, the image 1 is inputted as the input 2, and the sound 0 is inputted as the input 3 and a suitability determination result for when the image 0 is inputted as the input 1, the image 1 is inputted as the input 2, and the sound 2 is inputted as the input 3.

A method of calculating an evaluation value of each piece of input data is as described in FIGS. 5A and 5B.

In the fifth embodiment, assume that the first threshold and the second threshold are set to 2.

When the image 0, the image 1, and the sound 0 are inputted, respective evaluation values of the pieces of input data are 4 for image 0, 1 for image 1, and 3 for sound 0.

According to comparison of an evaluation value of each piece of input data with the first threshold, it is determined that the image 0 and the sound 0 are suitable due to the evaluation values being greater than or equal to the first threshold and it is determined that the image 1 is unsuitable due to the evaluation value being less than the first threshold.

According to comparison of an evaluation value of each piece of input data with the second threshold, since the highest evaluation value is 4 of the image 0 and the next highest evaluation value is 3 of the sound 0, a difference between the evaluation value of the image 0 and the evaluation value of the sound 0 is 1, and in this case, since the difference between the evaluation values is less than the second threshold, it is determined that all pieces of input data are suitable. The suitability determination unit 1603 determines that the image 0 is suitable, the image 1 is unsuitable, and the sound 0 is suitable from a suitability determination result according to comparison of the evaluation value of each piece of input data with the first threshold and the second threshold.

When the image 0, the image 1, and the sound 2 are inputted, respective evaluation values of the pieces of input data are 4 for image 0, 1 for image 1, and 2 for sound 2.

According to comparison of an evaluation value of each piece of input data with the first threshold, it is determined that the image 0 and the sound 2 are suitable due to the evaluation values being greater than or equal to the first threshold and it is determined that the image 1 is unsuitable due to the evaluation value being less than the first threshold.

According to comparison of an evaluation value of each piece of input data with the second threshold, since the highest evaluation value is 4 of the image 0 and the next highest evaluation value is 2 of the sound 2, a difference between the evaluation value of the image 0 and the evaluation value of the sound 2 is 2, and in this case, since the difference between the evaluation values is greater than or equal to the second threshold, it is determined that the image 0 is suitable and the image 1 and the sound 2 are unsuitable.

The sound 2 is suitable according to determination based on the first threshold but is unsuitable according to determination based on comparison with the second threshold, and so, the suitability determination unit 1603 prioritizes an unsuitable determination result and determines that the image 0 is suitable, the image 1 is unsuitable, and the sound 2 is unsuitable.

FIG. 18B illustrates substitute data decided based on a respective characteristic value calculated for a respective one of the image 0 and the image 1. FIG. 18C illustrates substitute data decided based on a respective characteristic value calculated for a respective one of the sound 0 and the sound 2.

The control unit 1601 decides substitute data based on a characteristic value of input data using the same method as in FIG. 6A of the first embodiment.

When the image 0 is inputted, the characteristic information calculation unit 1604 calculates a characteristic value of a high-sensitivity noise amount to be 7 and a characteristic value of a blur amount to be 8. The control unit 1601 decides substitute data of each characteristic value to be 2 as described in FIG. 6A.

When the image 1 is inputted, the characteristic information calculation unit 1604 calculates a characteristic value of a high-sensitivity noise amount to be 4 and a characteristic value of a blur amount to be 2. The control unit 1601 decides substitute data of a high-sensitivity noise amount to be 1 and substitute data of a blur amount to be 0 as described in FIG. 6A.

When the sound 0 is inputted, the characteristic information calculation unit 1604 calculates a characteristic value of noise sound to be 5 and a characteristic value of a sound volume to be 6. The control unit 1601 decides substitute data of noise sound to be 1 and substitute data of a sound volume to be 2 as described in FIG. 6A.

When the sound 2 is inputted, the characteristic information calculation unit 1604 calculates a characteristic value of noise sound to be 2 and a characteristic value of a sound volume to be 4. The control unit 1601 decides substitute data of noise sound to be 0 and substitute data of a sound volume to be 1 as described in FIG. 6A.

FIG. 18D is a diagram illustrating a method by which the control unit 1601 decides the inference data 1, the inference data 2, and the inference data 3 based on a suitability determination result of FIG. 18A and substitute data decided using FIGS. 18B and 18C.

When the image 0 is inputted as the input 1, the image 1 is inputted as the input 2, and the sound 0 is inputted the input 3, since the suitability determination unit 1603 determines that the image 0 is suitable, the image 1 is unsuitable, and the sound 0 is suitable as illustrated in FIG. 18A, the control unit 1601 outputs the image 0 determined to be suitable as the inference data 1 and the sound 0 determined to be suitable as the inference data 3. Further, the control unit 1601 outputs blur substitute data 2 with the highest characteristic value among the characteristic values of the image 0 and the sound 0 determined to be suitable as the inference data 2.

When the image 0 is inputted as the input 1, the image 1 is inputted as the input 2, and the sound 2 is inputted the input 3, since the suitability determination unit 1603 determines that the image 0 is suitable, the image 1 is unsuitable, and the sound 2 is unsuitable as illustrated in FIG. 18A, the control unit 1601 outputs the image 0 determined to be suitable as the inference data 1. Further, the control unit 1601 outputs the blur substitute data 2 and high-sensitivity noise substitute data 2 in order from the highest characteristic value among characteristic values of the image 0 determined to be suitable as the inference data 2 and the inference data 3.

In the present embodiment, when there are a plurality of pieces of input data determined to be unsuitable, substitute data are set in order from the highest characteristic value among the characteristic values of a piece of input data determined to be suitable, but the same piece of substitute data may be set.

### <Control Processing>

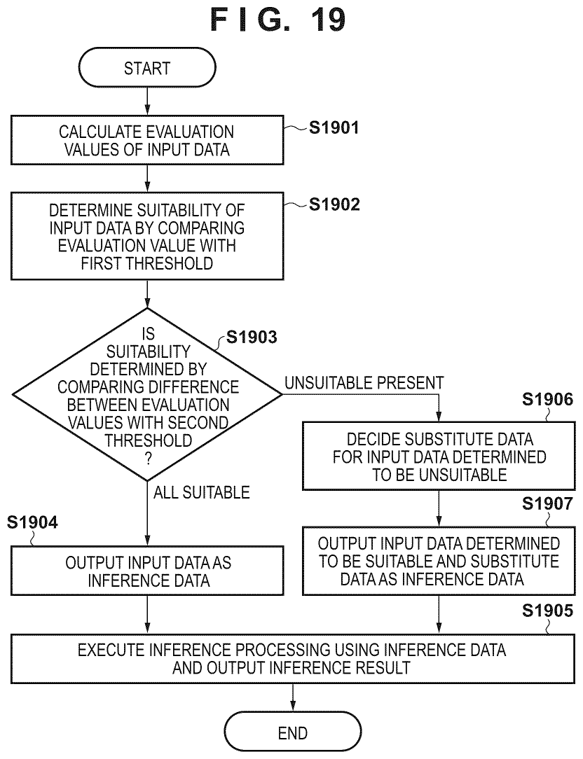

Next, processing for controlling the inference apparatus 1600 according to the fifth embodiment will be described with reference to FIG. 19.

The processing of FIG. 19 is realized by the control unit 1601 executing a program stored in a memory and is started by image data and sound data being inputted to the inference apparatus 1600.

In step S1901, the suitability determination unit 1603 calculates evaluation values of input data.

In step S1902, the suitability determination unit 1603 compares the evaluation values calculated in step S1901 with the first threshold. The suitability determination unit 1603 determines that input data is suitable when it is determined that an evaluation value is greater than or equal to the first threshold and determines that input data is unsuitable the evaluation value is determined to be less than the first threshold.

In step S1903, the suitability determination unit 1603 calculates a difference between the highest evaluation value and the next highest evaluation value for the evaluation values calculated in step S1902 and compares the difference between the evaluation values with the second threshold. When it is determined that the difference between the evaluation values is greater than or equal to the second threshold, the suitability determination unit 1603 determines suitabilities of the input data according to a result of suitability determination of step S1902. When it is determined that the difference between the evaluation values is less than the second threshold, the suitability determination unit 1603 determines all pieces of input data to be suitable regardless of the result of suitability determination of step S1902.

The suitability determination unit 1603 advances the processing to step S1904 when it is determined that all pieces of input data are suitable and advances the processing to step S1906 when there is a piece of input data determined to be unsuitable. In the present embodiment, when one piece of input data is determined to be suitable and unsuitable in steps S1902 and S1903, the determination that it is unsuitable is prioritized, but it is not limited thereto and it may be determined to be suitable.

In step S1904, the control unit 1601 outputs all pieces of input data as inference data to the inference unit 1602.

In step S1905, the inference unit 1602 computes the neural network using the inference data outputted from the control unit 1601, outputs an inference result, and terminates the processing.

In step S1906, the control unit 1601 decides characteristic value-based substitute data based on a characteristic value of a respective piece of data determined to be suitable.

In step S1907, the control unit 1601 outputs the data determined to be suitable and, in place of the data determined to be unsuitable, the substitute data decided in step S1906 as inference data and advances the processing to step S1905.

According to the fifth embodiment, for a plurality of pieces of input data, a suitability of each piece of input data is determined by comparing an evaluation value of each piece of input data with the first threshold and the suitability of each piece of input data is determined by comparing a difference between the highest evaluation value and the next highest evaluation value with a threshold. As a result of the determinations, the data determined to be suitable and, in place of the data determined to be unsuitable, substitute data decided based on a characteristic value of the data determined to be suitable are decided to be inference data to be outputted to the inference unit 1602. This makes it possible to, when there are a plurality of pieces of data determined to be unsuitable among a plurality of pieces of input data, use data determined to be suitable and, for the data determined to be unsuitable, substitute data decided from characteristics of the suitable data for the inference processing, and thereby, it is possible to improve inference accuracy compared to inference processing in which data determined to be unsuitable is used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-113901, filed Jul. 11, 2023 which is hereby incorporated by reference herein in its entirety.

What is claimed is:

1. An inference apparatus comprising:
an inference unit that executes inference processing using a plurality of pieces of inference data;
a determination unit that determines, for each of a plurality of pieces of input data inputted into the inference apparatus, whether each of the plurality of pieces of input data are suitable for the inference processing or unsuitable for the inference processing; and
a decision unit that decides, in place of input data determined to be unsuitable, substitute data based on input data determined to be suitable,
wherein the inference unit applies the input data determined to be suitable and the substitute data to an inference model as the plurality of pieces of inference data and executes the inference processing.

2. The apparatus according to claim 1, wherein
the decision unit calculates, for each of the plurality of pieces of input data, evaluation information for that input data, and
determines, for each of the plurality of pieces of input data, the suitability for when that piece of input data is used in the inference processing by comparing the evaluation information with a predetermined threshold.

3. The apparatus according to claim 2, wherein
in a case where all of the plurality of pieces of input data are determined to be suitable by the decision unit, the decision unit outputs those pieces of input data determined to be suitable as the plurality of pieces of inference data to the inference unit.

4. The apparatus according to claim 2, wherein
in a case where all of the plurality of pieces of input data are determined to be unsuitable by the decision unit, the decision unit changes a result of determination of a piece of input data whose evaluation information is the highest to suitable.

5. The apparatus according to claim 2, further comprising:
a calculation unit that calculates, for each of the plurality of pieces of input data, characteristic information of that piece of input data,
wherein the decision unit decides the substitute data based on characteristic information of a respective piece of input data.

6. The apparatus according to claim 5, wherein
the calculation unit calculates, for each of the plurality of pieces of input data, a plurality of pieces of characteristic information of that input data, and
the decision unit decides the substitute data based on a plurality of pieces of characteristic information of a respective piece of input data.

7. The apparatus according to claim 5, wherein
the characteristic information is a value for which a characteristic obtained for a respective piece of input data has been normalized by the calculation unit.

8. The apparatus according to claim 5, wherein
the plurality of pieces of input data include image data and sound data.

9. The apparatus according to claim 8, wherein
the evaluation information and the characteristic information include, in a case where the input data is the image data, a value related to either a blur amount, a luminance, or noise according to sensitivity at the time of capturing the image data, and
in a case where the input data is the sound data, a value related to a sound volume or noise sound.

10. The apparatus according to claim 9, wherein
the characteristic information includes, in a case where the input data is the image data, first characteristic information related to an amount of noise according to sensitivity at the time of capturing the image data and second characteristic information related to a blur amount of the image data, and
in a case where the input data is the sound data, first characteristic information related to noise sound and second characteristic information related to a sound volume, and
the decision unit decides the substitute data based on the first characteristic information and second characteristic information of a respective piece of input data.

11. The apparatus according to claim 5, wherein
the plurality of pieces of input data include a plurality of pieces of image data in which an orientation of a subject is different,
the evaluation information is a value corresponding to an orientation of a subject of a respective piece of image data, and
the characteristic information is a value related to a noise amount at the time of capturing a respective piece of image data.

12. The apparatus according to claim 5, wherein
the plurality of pieces of input data includes a plurality of pieces of image data that have been captured consecutively,
the evaluation information is a value corresponding to a luminance difference between a piece of image data succeeding in a time series and a piece of image data preceding in the time series, and
the characteristic information is a value related to a noise amount at the time of capturing a respective piece of image data.

13. The apparatus according to claim 5, wherein
the plurality of pieces of input data include three or more types of data including image data and sound data.

14. The apparatus according to claim 13, wherein
the decision unit determines, for each piece of plurality of input data, a suitability of that input data by comparing evaluation information calculated for that input data with a first threshold.

15. The apparatus according to claim 14, wherein
the decision unit obtains a difference between a highest piece of evaluation information and a next highest piece of evaluation information and, when it is determined that the difference is greater than or equal to a second threshold, determines a suitability of input data according to a result of determination based on the first threshold and, when it is determined that the difference is less than the second threshold, determines that all pieces of input data are suitable regardless of the result of determination based on the first threshold.

16. The apparatus according to claim 1, wherein
the inference unit executes the inference processing in which a trained inference model and parameters are used, and
regarding the inference model, training processing is executed in advance using training data including training input data and supervisory data.

17. The apparatus according to claim 16, wherein
the training input data includes a data set for which a plurality of pieces of input data determined to be suitable by the decision unit have been combined or a data set for which input data determined to be suitable by the decision unit and substitute data decided based on characteristic information of that input data have been combined.

18. The apparatus according to claim 1, wherein
the inference model is a neural network, and
the inference processing is deep learning using a neural network.

19. A method of controlling an interference apparatus operable to execute inference processing using a plurality of pieces of inference data, the method comprising:
determining, for each of a plurality of pieces of input data inputted into the inference apparatus, whether each of the plurality of pieces of input data are suitable for the inference processing or unsuitable for the inference processing; and
deciding, in place of input data determined to be unsuitable in the determining, substitute data based on input data determined to be suitable,
wherein the input data determined to be suitable and the substitute data are applied to an inference model as the plurality of pieces of inference data and the inference processing is executed.

20. A non-transitory computer-readable storage medium storing a program that when executed by a processor of a computing device, causes the computing device to function as an inference apparatus comprising:
an inference unit that executes inference processing using a plurality of pieces of inference data;
a determination unit that determines, for each of a plurality of pieces of input data inputted into the inference apparatus, whether each of the plurality of pieces of input data are suitable for the inference processing or unsuitable for the inference processing; and
a decision unit that decides, in place of input data determined to be unsuitable, substitute data based on input data determined to be suitable,
wherein the inference unit applies the input data determined to be suitable and the substitute data to an inference model as the plurality of pieces of inference data and executes the inference processing.
